(19) United States
(12) Patent Application Publication
(10) Pub. No.: US 2003/0030538 A1
(43) Pub. Date: Feb. 13, 2003

(54) ALLOWING TO PROVIDE SERVICE AND CHARGING COSTS ASSOCIATED WITH THE SERVICE

(76) Inventor: JOHN LESLY KINGSFORD BANNELL, GD RIJSWIJK (NL)

Correspondence Address: KIMBLEY L. MULLER, C/O SHELL OIL COMPANY, INTELLECTUAL PROPERTY, POST OFFICE BOX 2463, HOUSTON, TX, 772522463

(21) Appl. No.: 09/265,938

(22) Filed: Mar. 10, 1999

(30) Foreign Application Priority Data
Mar. 19, 1998 (EP) 98302064.5

(51) Int. Cl. G06F 7/04

(52) U.S. Cl. 340/5.4; 340/5.9

(57) ABSTRACT

A system for allowing to provide service and for charging the costs associated with providing the service to a vehicle or to a customer, which system comprises means for providing service to the vehicle, a vehicle recognition system capable of producing characteristic vehicle data, a customer recognition system capable of producing characteristic customer data, a data processing means which is connected to the recognition systems so as to receive the characteristic data, which data processing means includes a storage device including records containing characteristic data of the vehicle and the related customer, a system for comparing the produced characteristic data of the vehicle and the customer with the stored characteristic data, means for allowing the service to be provided when the produced characteristic data agree to one set of characteristic data of the vehicle and the related customer, and means for charging the costs to an account.

### FIELD OF THE INVENTION

The present invention relates to allowing to provide service at a service area of a fuel retail station. The service can be provided to the vehicle, for example refuelling the vehicle at the fuel dispenser or washing it at the car wash station, or to the customer, for example selling goods at a service shop at the fuel retail station. The present invention also relates to automatically charging the costs associated with the service.

### BACKGROUND OF THE INVENTION

U.S. Pat. No. 4,072,929 relates to a system for allowing to provide service to a vehicle or to a customer, which system comprises means for providing service to the vehicle, a vehicle recognition system in the form of a data entry terminal where a code identifying the vehicle has to be entered, a customer recognition system in the form of the data entry terminal where a code identifying the customer has to be entered, a data processing means which is connected to the recognition systems so as to receive the codes, which data processing means includes a storage device including records containing codes of the vehicle and the related customer, a system for comparing the codes of the vehicle and the customer with the stored codes, and means for allowing the service to be provided when the entered codes agree to one set of characteristic data of the vehicle and the related customer.

It is an object of the present invention to provide a simple system for allowing to provide service to a vehicle or to a customer, which system is secure and requires little activities of the customer, and which does not require entering data.

To this end the system for allowing to provide service to a vehicle or to a customer according to the present invention comprises means for providing service to the vehicle, a vehicle recognition system capable of producing characteristic vehicle data, a customer recognition system capable of producing characteristic customer data, a data processing means which is connected to the recognition systems so as to receive the characteristic data, which data processing means includes a storage device including records containing characteristic data of the vehicle and the related customer, a system for comparing the produced characteristic data of the vehicle and the customer with the stored characteristic data, and means for allowing the service to be provided when the produced characteristic data agree to one set of characteristic data of the vehicle and the related customer.

The system according to the present invention ensures that the service can only be provided if the data agree so that the vehicle has been recognized and also the customer related to that particular vehicle, or vice versa. When the data do not agree, the providing the service is prevented. Any customer can be linked to a number of vehicles, or a vehicle to a number of customers as required.

The vehicle recognition system is suitably an optical recognition system. Such an optical recognition system comprises an electronic camera, which produces an image of an object and a recognition system, which recovers relevant information from the image to produce the characteristic data of the object. The relevant information can relate to the information of the licence plate (or registration plate) optionally with information on the type and color of the vehicle and the produced characteristic vehicle data. The vehicle recognition system is so positioned that it can capture the vehicle when present at the service area. A system for optical recognition of characteristic features of a vehicle, for example the licence plate, is known, see for example U.S. Pat. No. 5,381,155.

### DESCRIPTION OF THE INVENTION

The customer recognition system is suitably a recognition system that is capable of recognizing an object, such as an optical recognition system, which captures at least part of the customer, for example the face, and which is capable of producing characteristic customer data. The customer recognition system is so positioned that it can capture the customer at any point where service is provided, for example the fuel dispenser, the counter of the service shop, the entrance of the car wash.

Alternatively, the recognition system is a palm print recognition system or a finger print recognition system, wherein an image of the hand palm or the finger is produced from which a recognition system, which recovers relevant information so as to produce the characteristic customer data. Such a system may be fitted to the fuel dispenser or it may be incorporated in the handle of the fuel filler nozzle. The customer recognition system may also be a system based on the recognition of the iris pattern of the eye, comprising a detailed iris pattern capture camera fitted to the fuel dispenser.

Suitably, the system further comprises means for charging the costs associated with the service to an account.

The storage device includes vehicle-customer information records each relating the characteristic data of a vehicle to the characteristic data of a customer. These data have to be entered into the storage device before any transaction can automatically be handled. The vehicle-customer information records thus relate vehicle data to data of an authorized customer to form a set of characteristic data of the vehicle and the related authorized customer. When there are more customers authorized for one vehicle, the characteristic data of the vehicle will be related to the characteristic data of each of the authorized customers; in this way sets are created of characteristic data of the vehicle and the related customer. In the same way sets can be formed when one customer is authorized for two or more vehicles.

Suitably the system for comparing the produced characteristic data of the vehicle and the customer with the stored characteristic data comprises a retrieval system for retrieving the characteristic data of the customer(s) belonging to the produced characteristic data of the vehicle, and a system which compares the produced characteristic customer data to the retrieved characteristic data of the customer(s) and which transmits an enabling signal to the means for allowing the service to be provided when the produced characteristic customer data agree to the retrieved characteristic data of one customer.

In order to allow charging the costs, the storage device further contains records each relating the characteristic data of a customer to the account to which the costs are to be charged.

The invention further relates to a method of allowing to provide service to a vehicle or a customer, wherein a data processing means is provided that includes a storage device including records containing characteristic data of the vehicle and the related customer, which method comprises according to the invention the steps of

(a) producing characteristic vehicle data of the vehicle to be serviced;

(b) producing characteristic customer data of the customer pertaining to the vehicle;

(c) comparing the produced characteristic vehicle data with stored characteristic vehicle data so as to retrieve stored characteristic data of the customer related to the vehicle, if the vehicle data agree;

(d) comparing the produced characteristic customer data with the retrieved characteristic customer data; and

(e) allowing the service to be provided if the customer data agree.

Suitably the method further comprises the step of charging the costs associated with the service to an account.

The use of two distinct recognition systems allows verification in two-stages: at first the characteristic data of the customer(s) authorized for a particular vehicle which is retrieved from the produced characteristic data of the vehicle, and then, the produced characteristic customer data are compared with the retrieved characteristic data of the authorized customer(s). Because the amount of data required to characterize a vehicle will be less than the amount of data required to characterize a person, the verification in two stages is very efficient. This is particularly relevant when the data processing means is a central data processing means which is connected to the particular service station, wherein the connection is an on-line connection or a connection through a satellite.

The coupling of these two recognition systems provides an enhanced level of security to the customer and vendor over use of either system independently.

An advantage of the system is that it permits the customer to access the facilities of the retail station without the need for any personalised electronic or card based identification or transaction system to be carried by the customer or attached to the vehicle, as long as both the vehicle and customer can be identified by their respective characteristics at any given time.

What we claim as our invention is:

1. A system to provide service to a vehicle or to a customer, which system comprises means for providing service to the vehicle, a vehicle recognition system capable of producing characteristic vehicle data, a customer recognition system capable of producing characteristic customer data, a data processing means which is connected to the recognition systems so as to receive the characteristic data, which data processing means includes a storage device including records containing characteristic data of the vehicle and the related customer, a system for comparing the produced characteristic data of the vehicle and the customer with the stored characteristic data, and means for allowing the service to be provided when the produced characteristic data agree to one set of characteristic data of the vehicle and the related customer.

2. The system according to claim 1, further comprising means for charging the costs associated with the service to an account.

3. The system according to claim 1, wherein the storage device includes vehicle-customer information records each relating the characteristic data of a vehicle to the characteristic data of a customer.

4. The system according to claim 3, wherein the system for comparing the produced characteristic data of the vehicle and the customer with the stored characteristic data comprises a retrieval system for retrieving the characteristic data of the customer (s) belonging to the produced characteristic data of the vehicle, and a system which compares the produced characteristic customer data to the retrieved characteristic data of the customer (s) and which transmits an enabling signal to the means for allowing the service to be provided when the produced characteristic customer data agree to the retrieved characteristic data of one customer.

5. The system according to claim 3, further comprising means for charging the costs associated with the service to an account, wherein the storage device further contains records each relating the characteristic data of a customer to the account to which the costs are to be charged.

6. A method of allowing to provide service to a vehicle or a customer, wherein a data processing means is provided that includes a storage device including records containing characteristic data of the vehicle and the related customer, which method comprises the steps of
(a) producing characteristic vehicle data of the vehicle to be serviced;
(b) producing characteristic customer data of the customer pertaining to the vehicle;
(c) comparing the produced characteristic vehicle data with stored characteristic vehicle data so as to retrieve stored characteristic data of the customer related to the vehicle, if the vehicle data agree;
(d) comparing the produced characteristic customer data with the retrieved characteristic customer data; and
(e) allowing the service to be provided if the customer data agree.

7. A method according to claim 6, further comprising charging the costs associated with the service to an account.
